(19) United States
(12) Patent Application Publication
(10) Pub. No.: US 2006/0250598 A1
(43) Pub. Date: Nov. 9, 2006

(54) Exposure apparatus and method

(75) Inventor: Ryo Sasaki, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/416,125

(22) Filed: May 3, 2006

(30) Foreign Application Priority Data
May 9, 2005 (JP) 2005-136676

(51) Int. Cl. G03B 27/52

(52) U.S. Cl. 355/55; 355/53

(57) ABSTRACT

An exposure apparatus includes a projection optical system for projecting an image of a first pattern of a reticle onto a target, a detecting system for detecting a mark via the projection optical system to focus the projection optical system on the target or to align the reticle and the target, and a controller for controlling driving of a component that is located closer to the reticle than the projection optical system when the detecting system detects.

### BACKGROUND OF THE INVENTION

The present invention relates generally to exposure methods and apparatuses that expose a pattern of a reticle (mask) to a target, such as a wafer and a glass target, and more particularly to a calibration for an alignment and focusing of an exposure apparatus, and the like. The present invention is suitable, for example, for an alignment for a so-called immersion exposure apparatus that fills, in liquid, a surface of a target and a final surface of a projection optical system, and exposes to the target via the projection optical system and the liquid.

A conventionally used projection exposure apparatus has a projection optical system and exposes a reticle pattern onto a wafer. Recently, a step-and-scan projection exposure apparatus has been mainly used. The exposure apparatus includes a reticle stage for driving a reticle, a wafer stage for driving a wafer, and a calibration system for an alignment and focusing. A precise calibration is required to improve a resolution and overlay accuracy.

Calibration optical systems include a through-the-reticle (“TTR”) optical system or a through-the-lens (“TTL”) optical system that uses the projection optical system. The TTR (Through The Reticle) calibration system is classified into two types according to measurement methods, and these types are common in driving the wafer stage in the XYZ directions at the measurement time.

A first TTR calibration system is of a light intensity detection type, which detects a light intensity that has transmitted an alignment mark (hereinafter called “an R mark”) on a reticle-side reference plate provided on the reticle or reticle stage and an alignment mark (hereinafter called “a W mark”) on a wafer-side reference plate provided on a wafer or wafer stage. A second TTR calibration system is of an image detection type, which uses an alignment scope (having a CCD) provided above the reticle to observe an image of the W mark via the reticle and the projection optical system.

Prior art includes, for example, Japanese Patent Applications, Publication Nos. 08-298238 and 2004-193160.

Both conventional TTR calibration systems have driven the wafer stage at the measurement time, but this approach come to have difficulties in satisfying the accuracy level required for the recent calibration. The wafer stage is driven during exposure in the step-and-scan method, but it is driven much faster during calibration than during exposure to prevent the throughput degradation. The fast movement fluctuates air between the final surface of the projection optical system and the wafer, degrading the measurement accuracy. In particular, an immersion type projection exposure apparatus that fills, in liquid, a space between the final surface of the projection optical system and the wafer suffers for substantially lowered measurement accuracy by the liquid turbulence. Even with no fluctuations of air or liquid between the final surface of the projection optical system and the wafer, the need still exists to enhance the calibration accuracy of the TTR calibration system.

### BRIEF SUMMARY OF THE INVENTION

The present invention is directed to an exposure apparatus and method that enhances the TTR calibration accuracy.

An exposure apparatus according to one aspect of the present invention includes a projection optical system for projecting an image of a first pattern of a reticle onto a target, a detecting system for detecting a mark via the projection optical system to focus the projection optical system on the target or to align the reticle and the target, and a controller for controlling driving of a component that is located closer to the reticle than the projection optical system when the detecting system detects.

An exposure method according to another aspect of the present invention includes the steps of detecting a mark via a projection optical system while driving a component, located closer to a reticle than the projection optical system in focusing the projection optical system on a target or aligning the reticle and the target in an exposure apparatus for projecting onto the target a pattern of the reticle supported and driven by a reticle stage via the projection optical system, moving the target based on a detected result, and exposing the target.

A device manufacturing method according to still another aspect of the present invention includes the steps of exposing a target using the above exposure apparatus, and developing the target exposed. Claims for a device manufacturing method for performing operations similar to that of the above exposure apparatus cover devices as intermediate and final products. Such devices include semiconductor chips like an LSI and VLSI, CCDs, LCDs, magnetic sensors, thin film magnetic heads, and the like.

Other objects and further features of the present invention will become readily apparent from the following description of the preferred embodiments with reference to the accompanying drawings.

### BRIEF DESCRIPTION OF THE DRAWINGS

FIG. 1 is a schematic block diagram of an exposure apparatus according to a first embodiment according to the present invention.

FIG. 2 is a plan view of an exemplary wafer-side alignment mark shown in FIG. 1.

FIG. 3 is a graph showing light intensity changes of the light that has transmitted the wafer-side alignment mark, detected by a light receiving element shown in FIG. 1.

FIG. 4 is a graph showing asymmetry of light having transmitted the wafer-side pattern, detected by the light receiving element shown in FIG. 1.

FIG. 5 is a schematic block diagram of a variation of the exposure apparatus shown in FIG. 1.

FIG. 6 is a schematic block diagram of an exposure apparatus according to a second embodiment of the present invention.

FIG. 7 is a plan view of an exemplary wafer-side alignment mark shown in FIG. 6.

FIG. 8 is a plan view of an exemplary reticle-side alignment mark shown in FIG. 6.

FIG. 9 is a schematic block diagram of an exposure apparatus according to a third embodiment of the present invention.

FIG. 10 is a flowchart for explaining a fabrication of devices (semiconductor chips such as ICs, LSIs, LCDs, and CCDs).

FIG. 11 is a detailed flowchart of the wafer process in Step 4 shown in FIG. 10.

### DETAILED DESCRIPTION OF THE PREFERRED EMBODIMENTS

Referring now to the accompanying drawings, a description will be given of the embodiments of the present invention.

### First Embodiment

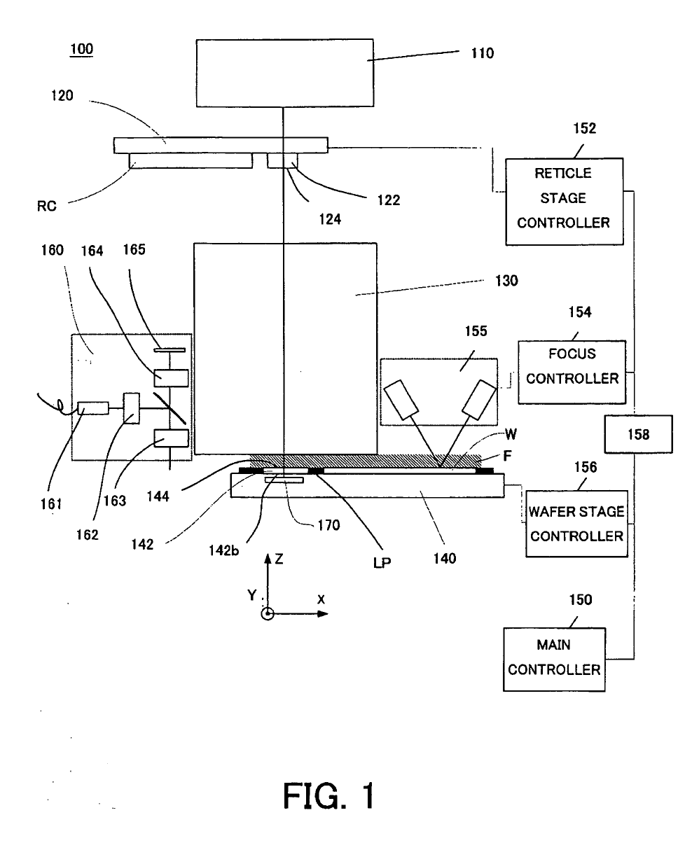

Referring now to FIG. 1, a description will be given of an exposure apparatus 100 of a first embodiment according to the present invention. Here, FIG. 1 is a schematic block diagram showing a configuration of the exposure apparatus 100.

The exposure apparatus 100 includes, as shown in FIG. 1, an illumination optical system 110, a reticle stage 120, a projection optical system 130, a wafer stage 140, a liquid F, a control system, an off-axis alignment optical system 160, a light receiving element 170, and a focus measuring system 172. The exposure apparatus 100 is an immersion exposure apparatus that partly or totally fills, in liquid F, a final surface of the projection optical system 130 at the wafer W's side, and exposes a pattern of a reticle RC onto the wafer W via the liquid F. The exposure apparatus of this embodiment is a step-and-scan projection exposure apparatus 100 (a so-called scanner), but the present invention is applicable to a step-and-repeat exposure apparatus (a so-called stepper) and other exposure apparatuses.

The exposure apparatus 100 provides a wafer-side reference plate 142 on the wafer stage 140, forms a reference mark (reticle-side pattern) 124 on the surface as a reference for an alignment between the reticle RC and the wafer W, and fills, in liquid F, the space between the wafer-side reference plate 142 and the projection optical system 130. This structure sets the R mark 124 on the reticle RC or reticle-side reference plate 122 and the W mark 144 in an imaging relationship via the projection optical system 130. This configuration detects a positional relationship between the R mark 124 and the W mark 144 via the projection optical system 130 and through use of the exposure light, thus carrying out a calibration such as a baseline measurement.

The illumination apparatus 110 illuminates the reticle RC on which a circuit pattern to be transferred is formed, and includes a light source section and an illumination optical system.

The light source section uses, e.g., a laser as a light source. The laser can use a beam from pulse laser such as an ArF excimer laser with a wavelength of about 193 nm, a KrF excimer laser with a wavelength of about 248 nm, and an F₂ excimer laser with a wavelength of about 157 nm. A kind of laser and the number of laser units are not limited, and a kind of a light source section is not limited.

The illumination optical system is an optical system that guides the light from the light source section to the reticle RC, and includes a lens, a mirror, a light integrator, a stop, and the like. The light integrator may include a fly-eye lens or an integrator formed by stacking two sets of cylindrical lens array plates (or lenticular lenses), and be replaced with an optical rod or a diffraction optical element. The illumination optical system can use any light whether it is axial light or non-axial light.

The reticle RC, on which a circuit pattern (or an image) to be transferred is formed, is made, for example, of quartz, and is supported and driven by the reticle stage 120. The diffracted lights through the reticle RC are projected onto the wafer W via the projection optical system 130. The reticle RC and wafer W are located in a conjugate relationship. Since the exposure apparatus 100 is a scanner, it transfers a pattern on the reticle RC onto the wafer W by scanning the reticle RC and plate W. If the exposure apparatus 100 is a stepper, it exposes while keeping the reticle RC and wafer W stationary.

The reticle stage 120 supports the reticle RC, is connected to a drive mechanism (not shown), and drives and controls the reticle RC. The reticle stage 120 and the projection optical system 130 are installed on a barrel stool supported via a damper, for example, to the base frame placed on the floor and the like. The drive mechanism (not shown) includes a linear motor and the like, and drives the reticle stage 120 in the XY directions, thus moving the reticle RC.

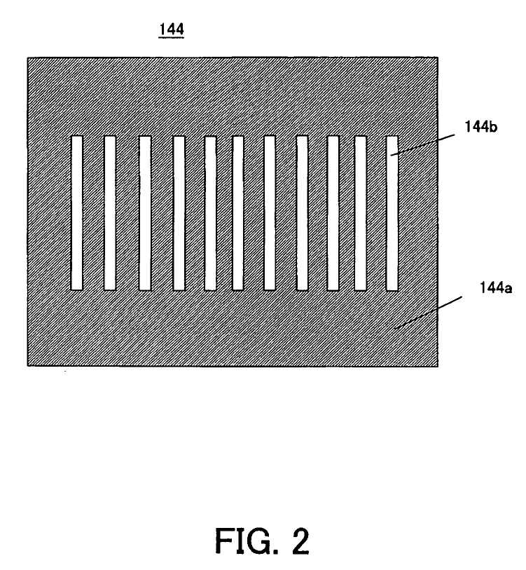

A reticle-side reference plate 122 is fixed within a specific range near the reticle RC on the reticle stage 120 such that the reticle-side reference plate 122's pattern surface is approximately level with that of the reticle RC's pattern surface. The reticle-side reference plate 122 has a plurality of R marks 124 for alignments on the pattern surface. The R mark 124 is different in size from the W mark 144 shown in FIG. 2 by a magnification of the projection optical system 130, but has a similar structure. Hence, a description thereof will be omitted. A critical dimension, a light shielding width, the number of lines of the pattern shown in FIG. 2 can be optimized according to the exposure condition, such as a type of the projection optical system 130, an exposure wavelength, and an illumination σ.

The projection optical system 130 serves to image the diffracted light that has passed a pattern of the reticle RC onto the wafer W. The projection optical system 130 can use a dioptric optical system consisting of a plurality of lens units, and a catadioptric optical system that includes a plurality of lens units and at least one concave mirror. Any necessary correction of a chromatic aberration may use a plurality of lens units made from glass materials having different dispersion values (Abbe values), or arranges a diffraction optical element such that it disperses in a direction opposite to that of the lens unit.

The wafer W is a plate to be exposed, and a photoresist is applied onto the plate. An alternate embodiment replaces the wafer W with a liquid crystal substrate or another plate to be exposed. The wafer W is supported by the wafer stage 140.

The wafer stage 140 supports the wafer W, and drives and controls the wafer W. The wafer stage 140 uses a linear motor to move the wafer W in the XYZ directions. The reticle RC and the wafer W are, for example, scanned synchronously, and the positions of the reticle stage 120 and wafer stage 140 are monitored, for example, by a laser interferometer and the like, so that both are driven at a constant speed ratio. The wafer stage 140 is installed on a stage stool supported on the floor and the like, for example, via a damper.

A wafer-side reference plate 142 is fixed within a specific range near the wafer W on the wafer stage 140 such that the wafer-side reference plate 142's pattern surface is approximately level with that of the wafer W's top surface (i.e., the projection optical system 130's imaging surface).

The wafer-side reference plate 142 has multiple W marks 144 for position alignment on the pattern surface. As shown in FIG. 2, the W mark has a repetitive pattern of a light shielding part 144a and a light transmitting part 144a, and this embodiment makes different a critical dimension and a pitch, and the like of the light shielding part 144a and light transmission part 144b by a magnification of the projection optical system 130. Here, FIG. 2 is a plan view showing the exemplary W mark 144 on the wafer-side reference plate 142.

The liquid F in which the final surface of the projection optical system 130 is immersed adopts a material that has a good transmittance to the exposure wavelength, does not contaminate the projection optical system 130, and is well matched with the resist process. In order to make large the NA of the projection optical system 130, the liquid F uses the material having a refractive index larger than 1. The refractive element (or a lens) of the projection optical system 130 is protected with coating on the final surface that contacts the liquid F.

As stated above, the liquid F fills the space between the final surface of the projection optical system 130 and the W mark 144 on the wafer-side reference plate 142, and serves to set the R mark 124 and the W mark 144 in an imaging relationship via the projection optical system 130.

In projecting and exposing a pattern on the reticle RC onto the wafer W, the exposure apparatus 100 should align the reticle RC with the wafer W, and thus includes an alignment mechanism. The alignment mechanism includes the off-axis alignment optical system 160 that detects the W mark 144 on the wafer W or the wafer-side reference plate 142, and a light intensity detection type calibration system that detects, via the projection optical system 130, the position of the W mark 144 on the wafer W 144 or the wafer-side reference plate 142 corresponding to the R mark 124 on the reticle RC or the reticle-side reference plate 122.

The off-axis alignment optical system 160 serves to detect the position of the wafer W, and includes an alignment light source (not shown), a fiber 161, an illumination section 162, an objective lens 163, a relay lens 164, and an image sensor 165.

The off-axis alignment optical system 160 uses the fiber 161 to guide a non-exposure light emitted from the alignment light source to the illumination section 162, and illuminates the W mark. The illuminated W mark is enlarged using the objective lens 163 and the relay lens 164, and imaged on the image sensor 165 such as a CCD. The off-axis alignment optical system 160 detects the position of the wafer W by utilizing a fact that an image position on the image sensor 165 changes as the W mark's position changes. However, when the off-axis alignment optical system 160 aligns the wafer W at a non-exposure position, it cannot provide an accurate alignment if the relationship (baseline) between the exposure position and the alignment position changes due to environmental changes and so forth.

To perform alignment with higher precision than the baseline stability, the calibration system measures the baseline. At first, the illumination apparatus 110 irradiates the exposure light onto the R mark that is located on the reticle-side reference plate 122 or the reticle RC, and has a guaranteed position relative to the reticle RC, and the projection optical system 130 projects it onto the W mark 144 on the wafer stage 140.

The light receiving element 170 receives the light that has transmitted the W mark 144, and is located on a backside 142b of the surface that has the W mark 144 of the wafer-side reference plate 142. This embodiment configures the light receiving element 170 as a light intensity sensor, such as a photodiode, which detects the intensity of the light that has transmitted the W mark 144. In projecting the R mark 124 onto the W mark 144 via the projection optical system 130, the light receiving element 170 detects the light intensity that has passed the wafer-side reference plate 142.

The control system includes a main control system 150, a reticle stage driving control system 152, a focus control system 154, and a wafer-stage driving control system 158. The main control system 150 communicates with and controls each control system. For example, the main control system 150 controls synchronous scanning between the reticle stage 120 and the wafer stage 140 during scan exposure of a reticle pattern onto the wafer W, including control over an exposure plane position based on an output of the focus control system 155. The main control system 150 directs the illumination optical system 110 to illuminate the R mark 124 with the exposure light, and to project it via the projection optical system 130 onto the W mark. The main control system 150 also calculates a calibration value. The reticle-stage driving control system 152 controls driving of the reticle stage 120. The focus control system 154 controls the focus measuring system 155. The focus measuring system 155 irradiates an obliquely light onto a plane to be measured, and calculate the height and inclination of the plane using the light reflected from the plane. The wafer-stage driving control system 158 controls driving of the wafer stage 140.

The R mark 124 is projected onto the W mark 144 via the projection optical system 130, and while the reticle stage 120 is moved in an X direction, the light receiving element 170 detects a light intensity having transmitted the W mark 144. This is different from a conventional exposure apparatus in that the reticle stage 120 is driven instead of the wafer stage 140. Since the liquid F does not fluctuate, this configuration implements a precise calibration of a light intensity detection type.

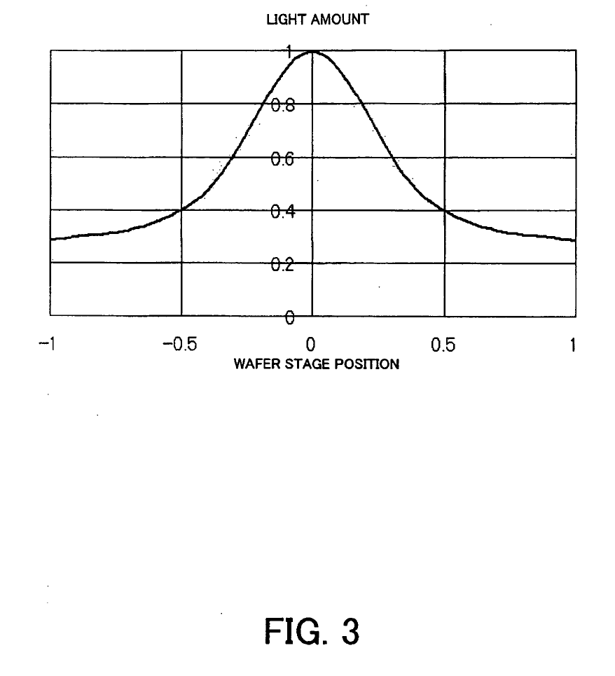

FIG. 3 is a graph showing a change in a light intensity that has transmitted the W mark 144, which is detected by the light receiving element 170, where the ordinate axis denotes a light intensity, and the abscissa axis denotes a position of the wafer stage 140. Referring to FIG. 3, it is understood that the light intensity becomes maximum where the R mark 124's image accords with the W mark 144's position. This configuration can measure an exposure position of the R mark by the projection optical system 130. Similarly, when both the R mark and W mark are rotated by 90° on the XY plane and the reticle stage 120 is moved in the Y direction, the exposure position of the R mark can be accurately measured in the Y direction via the projection optical system 130.

Next, when the wafer stage 140 is driven and the off-axis alignment optical system 160 detects a position of the W mark 144, a distance (baseline) between the R mark 124 and the off-axis alignment optical system 160 can be calculated for an alignment between the reticle RC and the wafer W. In place of the W mark 144, the off-axis alignment optical system 160 may detect another pattern having a guaranteed position with the W mark 144.

In detecting the W mark 144 using the off-axis alignment optical system 160, it is optional to fill, in the liquid F, the space between the off-axis alignment optical system 160 and the W mark 144. However, if filled, it is preferable that the space between the off-axis alignment optical system 160 and the wafer W be also filled. If not filled, the space between the off-axis alignment optical system 160 and the wafer W is preferably not filed. In other words, it is preferable to detect the position of the wafer-side reference plate 142 under the same condition as that of detecting the position of the wafer W using the off-axis alignment optical system 160.

The light receiving element 170 can also obtain the intensity change of the light that has transmitted the W mark 144, when the wafer stage 140 is driven in the axial direction (Z direction) of the projection optical system 130 while the calibration system aligns the R mark 124's image with the W mark 144 in the XY directions. Since the light intensity becomes maximum at the best focus position where the R mark 124 is focused on the W mark 144, the projection optical system 130's focusing position can be detected.

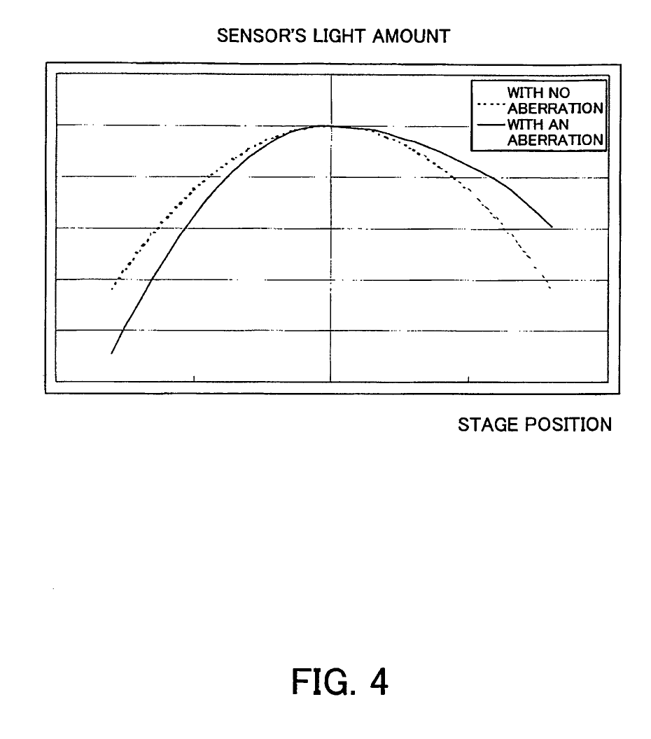

Further, the projection optical system 130's aberration (imaging performance) can also be calculated by measuring a change of a light intensity in detail as the wafer stage 140 is driven. For example, when the projection optical system 130 has a spherical aberration, a change in the light intensity shows asymmetry as shown in FIG. 4 when the wafer stage 140 is moved in the Z direction. Evaluation of a degree of such asymmetry will enable the spherical aberration of the projection optical system 130 to be calculated. A coma aberration can also be calculated by evaluating asymmetry due to a change in the light intensity when moving the wafer stage 140 in the Y or Z direction.

When the wafer-side reference plate 142 is provided on the wafer stage 140, and the liquid F is filled in the space between the projection optical system 130 and the W mark 144 (wafer-side reference plate 142), the R mark 124 can be imaged on the W mark successfully, providing a precise calibration in the same way as the conventional. In order to fill, in the liquid F, the space between the wafer-side reference plate 142 and the projection optical system 130 in the same condition as the space between the wafer W and the projection optical system 130, a liquid holding plate LP may be provided on the wafer stage 140. The liquid holding plate LP serves to fill a gap between the wafer W and the wafer-side reference plate 142, and is made of a material that levels the wafer-side reference plate 142's pattern surface to the wafer W's top surface. To eliminate the gap between the wafer W and the wafer-side reference plate 142, the wafer-side reference plate 142 may be located close to the wafer W.

The exposure apparatus 100 maintains an imaging relationship between the R mark 124 and the W mark 144, and provides a precise calibration by setting the wafer-side reference plate 142 on the wafer stage 140, and filling, in the liquid F, the space between the projection optical system 130 and the wafer-side reference plate 142.

However, the exposure apparatus 100 has a air or vacuum region having a refractive index of 1 between the wafer-side reference plate 142 and the light receiving element 170. When the light with an NA larger than 1 images the R mark 124 on the reticle-side reference plate 122 onto the W mark 144 on the wafer-side reference plate 142, the lights with the NA greater than 1 are totally reflected on the backside 142b of the wafer-side reference plate 142, thus being unable to enter the light receiving element 170. As a consequence, a measurement value becomes incorrect due to an offset in it and degraded reproducibility of the measurement. Especially, in detecting a focal position of the projection optical system 130 by moving the wafer-side reference plate 142 in the axial direction of the projection optical system 130 (Z direction), the light with a high NA, which is most sensitive to the focus changes, does not enter the light receiving element 170, lowering the measurement precision. It is therefore preferable to fill, in liquid, a space between the backside 142b of the wafer-side reference plate 142 and the light receiving element 170. The liquid may use the same as or different from the liquid F as long as the exposure light is not totally reflected on the backside 142b.

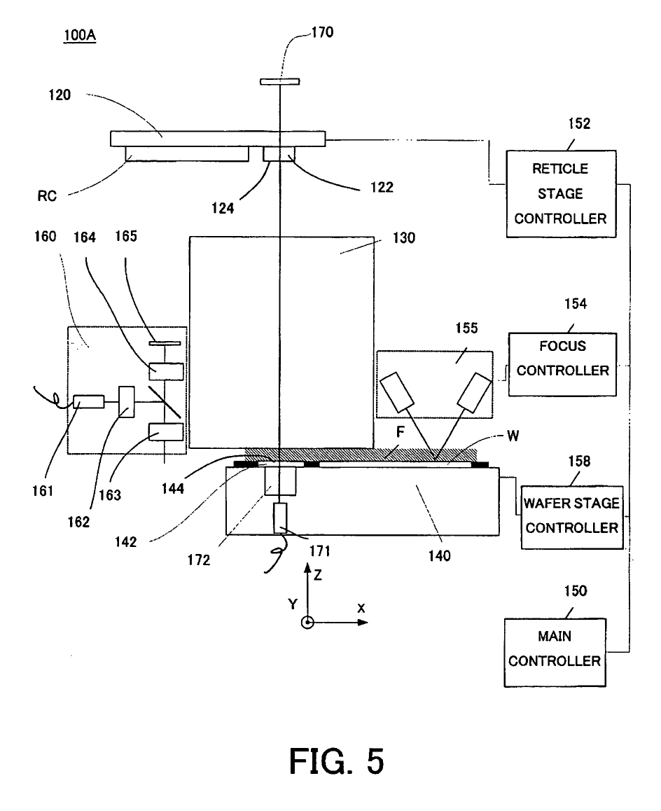

The exposure apparatus 100 is replaceable with an exposure apparatus 100A shown in FIG. 5. The exposure apparatus 100A introduces the light from a light source (not shown) using the fiber 171 to a light irradiator 172 installed on the wafer stage 140, and illuminates the W mark 144. The intensity of the transmitted light through the W mark 144 passes the projection optical system 130 and the R mark 124, and is detected by the light receiving element 170. In this case, the light receiving element 170 detects the light intensity that has passed the reticle-side reference plate 122 in projecting the R mark 124 onto the W mark 144 via the projection optical system 130.

As described above, the light intensity detection type calibration is implemented by driving the reticle stage 120 instead of driving the wafer stage 140, thus successfully detecting the R mark and W mark without fluctuations of the liquid F and precisely calibrating the exposure apparatuses 100 and 100A.

### Second Embodiment

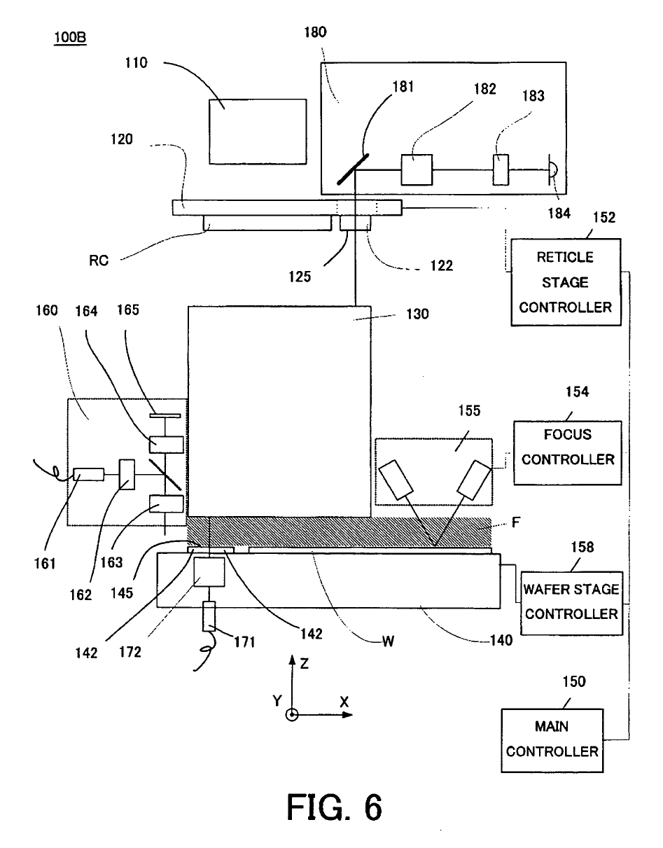

Referring now to FIG. 6, a description will be given of an exposure apparatus 100B according to a second embodiment of the present invention. Here, FIG. 6 is a schematic block diagram of the exposure apparatus 100B. Those reference numerals in FIG. 6, which are the same as corresponding elements in FIGS. 1 and 5, are designated by the same reference numerals, and a description thereof will be omitted.

The exposure apparatus 100B is different from the exposure apparatuses 100 and 100A in that it uses an alignment scope 180 such as an objective lens 182 and a relay lens 183 to image the R mark 122 and the W mark 144 onto an image sensor 184, and drives the reticle stage 120 to detect a positional relationship between the R mark 124 and the W mark 144 by an image detection method. The liquid F does not fluctuate during measurements by the calibration system, and a precise image detection calibration can be implemented.

A light source for the alignment scope 180 preferably uses the same wavelength as the exposure wavelength, or typically the exposure light source. The light from the exposure light source (not shown) is guided by the fiber 171 to the light irradiator 172, which, in turn, illuminates the W mark 145. The illuminated W mark 145 is enlarged by using the projection optical system 130, the mirror 181, the objective lens 182, and the relay lens 183, and then imaged onto the image sensor, such as a CCD.

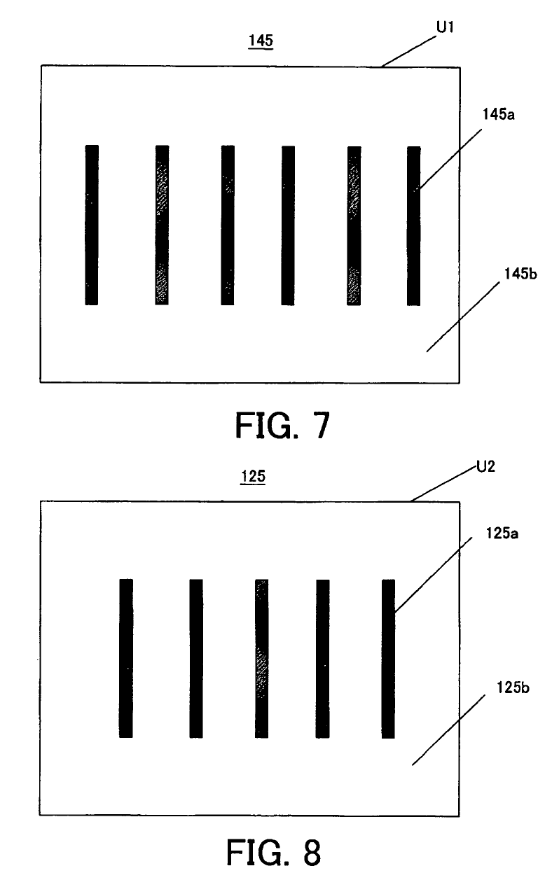

FIG. 7 shows an exemplary W mark 145. U1 is an observation area of the image sensor 184. 145a denotes a light shielding part, and 145b denotes a light transmitting part. According to the exposure condition, such as a type of the projection optical system 130, an exposure wavelength, and an illumination σ, shapes of the light shielding and transmitting parts, the number of light shielding lines, etc. can be optimized. In addition to the objective lens 182 and the relay lens 184, another optical system may be added to improve a magnification. The R mark 125 is illuminated using the light that transmits the wafer-side reference plate 142 other than the mark of and passes the projection optical system 130.

FIG. 8 shows an exemplary R mark 125. U2 is the observation area of the image sensor 184. 125a denotes a light shielding part, and 125b denotes a light transmitting part. According to the exposure condition, such as a type of the projection optical system 130, an exposure wavelength, and an illumination σ, shapes of the light shielding and transmitting parts, the number of light shielding lines, etc. can be optimized. The illuminated R mark 125 is enlarged and imaged onto the image sensor by using the objective lens 182 and the relay lens 183. Since the exposure light is used, the R mark 125 and the W mark 145 are maintained in the same imaging relationship as that during exposure. As shown in FIGS. 7 and 8, when the R mark and the W mark are arranged so that they are imaged at different positions within a field of the image sensor 184, the same optical system can simultaneously detect them. As a result, the exposure position of the R mark 125 can be accurately measured with high precision without influence of the optical system's errors and the like.

For measurement precision, it is preferable that a calibration system of an image observation type measure while the R mark 125's image and the W mark 145's image are each focused on the image sensor. Changing of the position of the relay lens 183 enables the focal points of the R mark 125's image and the W mark 145's image to be observed on the image sensor. The acquired relationship between the reticle-side and wafer-side focal points enables the R mark 125 to be successfully imaged on the wafer-side reference plate 124 for a precise calibration.

The R mark 125 can be focused on the image sensor 184 by moving the reticle stage 120 in the Z direction. The R mark 125 and W mark 145 each can be focused on the image sensor 184 by a combination of driving of the relay lens 183 and driving of the reticle stage 120 in the Z direction.

The image detection type calibration system, after the R mark 125 and the W mark 145 are focused on the image sensor 184, can basically measure an alignment between the W mark 145 and the R mark 125 without driving the wafer stage 140 and the reticle stage 120. However, when the R mark 125 and the W mark are located out of a sensing range of the image sensor, or a more precise measurement is required, the W mark 145 and the R mark 125 are moved to the image sensor's fine sensing range before the alignment measurement is carried out. At that time, instead of moving the wafer stage 140, the reticle stage 120, the image sensor 184, or the alignment scope 180 is moved in a direction perpendicular to the Z direction. This enables the W mark 145 and the R mark 125 to be observed within the fine sensing range of the image sensor, and provides a precise calibration without stirring the liquid F.

After the calibration, the wafer stage 140 is driven similarly to the first embodiment, and the off-axis alignment detection system 160 detects a position of the W mark 144. This guarantees the baseline, and aligns the reticle RC with the wafer W.

The imaging performance of the projection optical system 130 can be evaluated when the projected images of the R mark 125 and the W mark 145 on the image sensor 184 are thoroughly measured. In other words, the imaging performance of the TTR alignment system 180 can be observed by the detected image of the R mark 125, and the imaging performance of the projection optical system 130 via the TTR alignment system 180 can be observed by the detected image of the W mark 145. By calculating the optical performance of the R mark 125 and W mark 145 from their detected images, the optical performance of the projection optical system 130 alone can be calculated. For example, as the projection optical system 130 and the TTR alignment system 180 have a spherical aberration, a minimum output value in the light intensity distribution on the image sensor 184 increases for each light transmitting part of the R mark 125 and W mark 145. The spherical aberration of the projection optical system 130 can be measured by evaluating a change of this image sensor 184's minimum output value. A coma can also be measured by evaluating an asymmetry of the intensity distribution on the image sensor 184 for each transmitting part of the R mark 125 and W mark 145.

### Third Embodiment

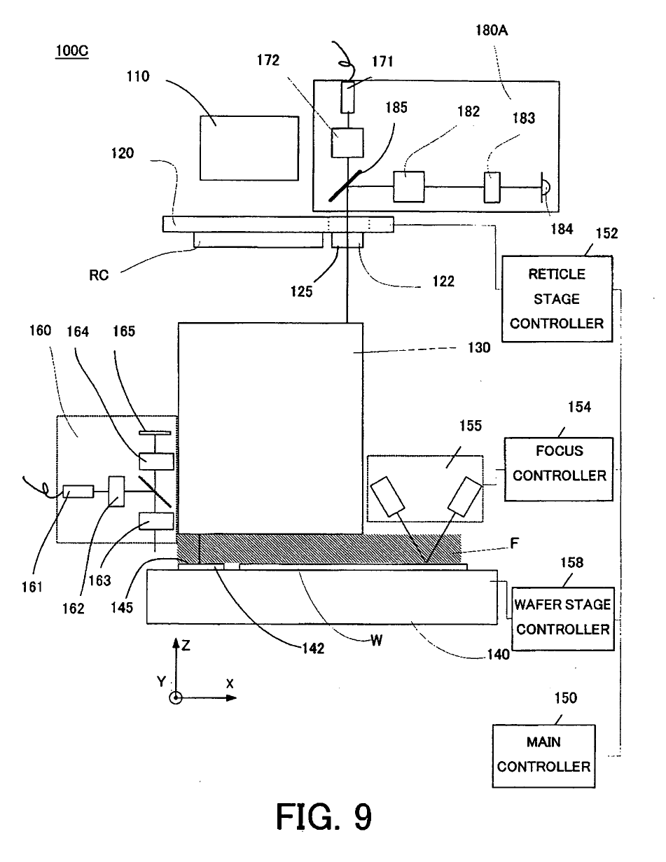

Referring now to FIG. 9, a description will be given of an exposure apparatus 100C according to a third embodiment of the present invention. Here, FIG. 9 is a schematic block diagram of the exposure apparatus 100C. Those elements in FIG. 9, which are the same as corresponding elements in FIG. 6, are designated by the same reference numerals, and a description thereof will be omitted. The exposure apparatus 100C is different from the exposure apparatus 100B in that a location of the illumination light of the alignment scope 180 is changed from the wafer stage 140 to the inside of the alignment scope 180.

A light from an exposure light source (not shown) is guided by the fiber 171 to the light irradiator 172 that is installed in the TTR alignment optical system, transmits a half-mirror 185, and illuminates the R mark 125. The light reflected on the illuminated R mark 125 is enlarged by the half-mirror 185, the objective lens 182, and the relay lens 183, and imaged to the image sensor 184. In addition to the objective lens 182 and the relay lens 183, another optical system may be added to improve the magnification. In place of the half-mirror 185, a polarized beam splitter and the like may be used.

This embodiment uses detection marks 145 and 125. 145a and 145b in FIG. 7 denote a light reflecting part and a light transmitting part, respectively, and 125a and 125b in FIG. 8 denote a light reflecting part and a transmitting part, respectively. A light transmits the light transmitting part 125b, passes the projection optical system 130, and illuminates the W mark 145. A light reflected from the illuminated W mark 145 is enlarged and imaged on the image sensor 184 by the projection optical system 130, the objective lens 182 and the relay lens 184 of the alignment scope 180. Since the exposure light is used, the R mark 125 and the W mark 145 are maintained in an imaging relationship as that during exposure. When the R mark and the W mark are arranged so that they are imaged at different positions within a field of the image sensor 184, the same optical system can simultaneously detect them. As a result, the exposure position of the R mark 125 can be accurately measured with high precision without influence of the optical system's errors and the like. Similar to the exposure apparatus 100B, this embodiment images the R mark 125 and the W mark 145 on the image sensor 184, and provides a precise calibration without driving the wafer stage 140.

While the above embodiments relate to the illustrative immersion exposure apparatus, the present invention is effectively applicable to dry exposure as well. A calibration for the dray exposure apparatus can use an oblique incidence type photo-detecting wafer-stage surface-position measuring system or an interferometer-type wafer-stage control system to drive and control a wafer stage. The wafer-stage surface-position measuring system and the control system are susceptible to air fluctuations in the optical path. When the air around the wafer stage is stirred when it is driven, the calibration accuracy deteriorates. The calibration system of this embodiment drives the reticle stage instead of the wafer stage, and does not stir the air near the wafer stage, realizing a precise calibration. When the reticle stage and wafer stage have similar driving and control errors, the reticle stage's driving error and control error are less influential to the calibration precision by the magnification of a projection optical system. When only a driving system is addressed after a similar driving system to that for the wafer stage is applied to the reticle stage, the calibration becomes more precise by an inverse of the reduction of the projection optical system (e.g., four times). Thus, the dry exposure apparatus can obtain a precise calibration through a reticle-stage driving calibration system. The step-and-scan method is expected to reduce influence by the liquid and air fluctuations in driving the wafer stage. This embodiment intends to maintain the calibration precision by stabilizing the wafer stage during calibration that requires the stage to be driven faster than during exposure.

### Fourth Embodiment

When the above calibration system detects an optimal position of the wafer W, the main control system 150 returns the reticle RC and the relay lens 183 (or the alignment scope 180) to the exposure position, and instead drives the wafer stage 140 by the reduction of the projection optical system 130 times the detected amount. The throughput is maintained by driving the reticle stage and the relay lens 184 (or the alignment scope 180) simultaneously with driving of the wafer stage 140.

The main control system 150 now carries out exposure. In exposure, the exposure light emitted from the illumination apparatus 110 Koehler-illuminates the reticle RC. The light that passes the reticle RC and reflects the reticle pattern is imaged via the projection optical system onto the wafer W. Due to the precise calibration, the exposure apparatuses 100 etc. precisely align the reticle RC and the wafer W, focus the projection optical system 130 on the wafer W, correct an aberration of the projection optical system 130, and provide higher quality devices than ever (such as semiconductor devices, LCD devices, image sensors (CCD and the like), and thin-film magnetic heads).

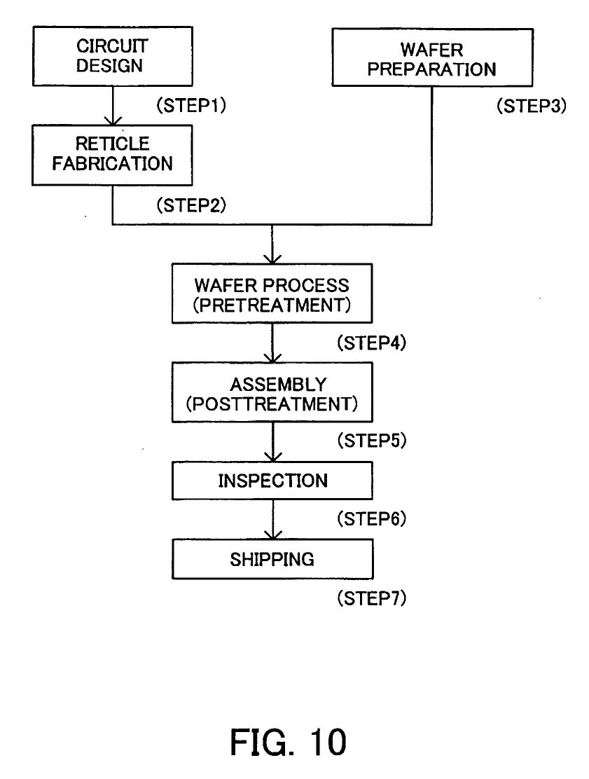

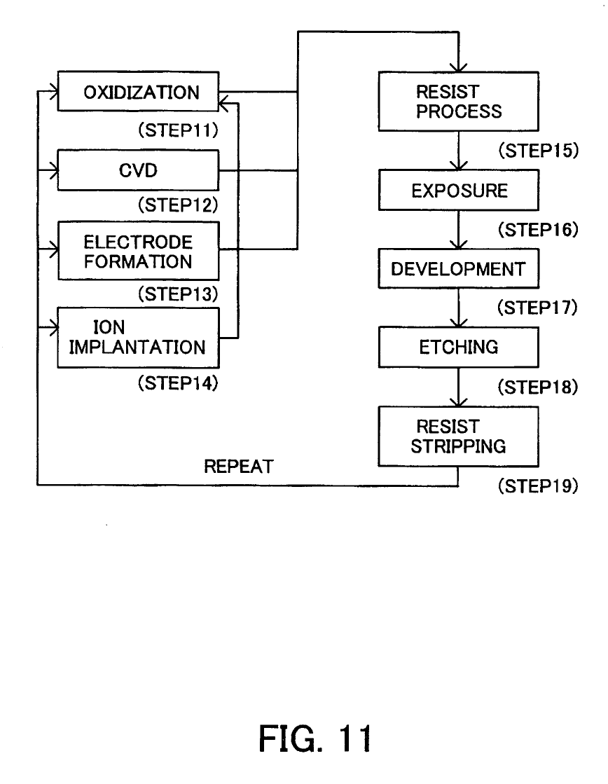

Referring now to FIGS. 10 and 11, a description will be given of an embodiment of a device manufacturing method using the above exposure apparatuses. FIG. 10 is a flowchart for explaining fabrication of devices (i.e., semiconductor chips such as IC and LSI, LCDs, CCDs, etc.). Here, a description will be given of the fabrication of a semiconductor chip as an example. Step 1 (circuit design) designs a semiconductor device circuit. Step 2 (reticle fabrication) forms a reticle that has a designed circuit pattern. Step 3 (wafer preparation) manufactures a wafer using materials such as silicon. Step 4 (wafer process), which is also referred to as a pretreatment, forms actual circuitry on the wafer through photolithography of the present invention using the reticle and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 11 is a detailed flowchart of the wafer process in Step 4. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the above exposure apparatus to expose a circuit pattern of the reticle onto the wafer. Step 17 (development) develops the exposed wafer. Step 18 (etching) etches parts other than a developed resist image. Step 19 (resist stripping) removes disused resist after etching. These steps are repeated, and multilayer circuit patterns are formed on the wafer. The device manufacturing method of this embodiment can manufacture devices with higher quality than ever. Thus, the device manufacturing method using the above exposure apparatus as well as devices as resultant products constitutes one aspect of the present invention.

Further, the present invention is not limited to these preferred embodiments, and various variations and modifications may be made without departing from the scope of the present invention.

This application claims a foreign priority benefit based on Japanese Patent Applications No. 2005-136676, filed on May 9, 2005, which is hereby incorporated by reference herein in its entirety as if fully set forth herein.

What is claimed is:

1. An exposure apparatus comprising:
a projection optical system for projecting an image of a first pattern of a reticle onto a target;
a detecting system for detecting a mark via the projection optical system to focus the projection optical system on the target or to align the reticle and the target; and
a controller for controlling driving of a component that is located closer to the reticle than the projection optical system when said detecting system detects.

2. An exposure apparatus according to claim 1, further comprising a reticle stage for supporting and driving the reticle, wherein the component is the reticle stage.

3. An exposure apparatus according to claim 1, wherein said mark is formed on the reticle,
said detecting system includes:
a target-side reference plate that is located on a target stage and has a second pattern, the target stage supporting and driving the plate; and
a light intensity detector for detecting a light intensity that has passed the target-side reference plate, the light intensity detector detecting the light intensity that has passed the target-side reference plate when the mark on the reticle is projected via the projecting optical system onto the second pattern of the target-side reference plate.

4. An exposure apparatus according to claim 1, wherein said detecting system includes:
a reticle-side reference plate that is located on a reticle stage and has the mark, the reticle stage supporting and driving the reticle;
a target-side reference plate that is located on a target stage and has a second pattern, said target stage supporting and driving the target; and
a light intensity detector for detecting a light intensity that has passed the target-side reference plate, the light intensity detector detecting the light intensity that has passed the target-side reference plate when the mark of the reticle-side reference plate is projected via the projection optical system onto the second pattern of the target-side reference plate.

5. An exposure apparatus according to claim 1, wherein said detecting system includes:
a target-side reference plate that is located on a target stage and has the mark, said target stage supporting and driving the target; and
a light intensity detector for detecting a light intensity that has passed the reticle, the light intensity detector detecting a light intensity that has passed the reticle when the mark of the target-side reference plate is projected via the projection optical system onto the first pattern of the reticle.

6. An exposure apparatus according to claim 1, wherein said detecting system includes:
a reticle-side reference plate that is located on a reticle stage, and has a second pattern, the reticle stage supporting and driving the reticle;
a target-side reference plate that is located on a target stage, and has the mark, said target stage supporting and driving the target; and
a light intensity detector for detecting a light intensity that has passed the reticle-side reference plate, the light intensity detector detecting the light intensity that has passed the reticle-side reference plate when the mark of the target-side reference plate is projected via the projection optical system onto the second pattern of the reticle-side reference plate.

7. An exposure apparatus according to claim 1, wherein said detecting system includes an alignment scope for an alignment between the reticle and the target, the alignment scope including an image sensor for imaging the mark, and a relay lens for relaying an optical image of the mark to the image sensor, and the component being one of the alignment scope and the relay lens.

8. An exposure apparatus according to claim 1, wherein said detecting system detects an imaging performance of the projection optical system.

9. An exposure apparatus according to claim 1, wherein a liquid exists between a final surface of the projection optical system and the target, the target being exposed via the projection optical system and the liquid.

10. An exposure method comprising the steps of:
detecting a mark via a projection optical system while driving a component, located closer to a reticle than the projection optical system in focusing the projection optical system on a target or aligning the reticle and the target in an exposure apparatus for projecting onto the target a pattern of the reticle supported and driven by a reticle stage via the projection optical system;
moving the target based on a detected result; and
exposing the target.
